(19) United States
(12) Patent Application Publication
(10) Pub. No.: US 2008/0086255 A1
(43) Pub. Date: Apr. 10, 2008

(54) Motor Vehicle And Control Method Of The Same

(76) Inventors: Keijiro Oshima, Aichi-ken (JP); Hideto Watanabe, Aichi-ken (JP)

Correspondence Address: KENYON & KENYON LLP, 1500 K STREET N.W., SUITE 700, WASHINGTON, DC, 20005, US

(21) Appl. No.: 11/632,904

(22) PCT Filed: Aug. 29, 2005
(86) PCT No.: PCT/JP05/16160

§ 371 Date: Jan. 19, 2007

(30) Foreign Application Priority Data
Sep. 1, 2004 (JP) 2004-254351

(51) Int. Cl. G06F 19/00

(52) U.S. Cl. 701/101

(57) ABSTRACT

A gear change from a parking position is predicted, in response to an ON operation of a gearshift cancellation button concurrently with the driver's depression of a brake pedal. The control procedure of the invention sets an auxiliary driving force F* in a direction of canceling a force, which acts in a longitudinal direction of a motor vehicle based on a road surface gradient θ. When the auxiliary driving force F* is less than a preset driving force F1, a motor MG2 is controlled to output the auxiliary driving force F*. When the auxiliary driving force F* is not less than the preset driving force F1, on the other hand, motors MG2 and MG3 are controlled to cooperatively output the auxiliary driving force F*. This arrangement effectively reduces the force in the longitudinal direction of the motor vehicle applied to a parking mechanism and ensures a smooth gearshift operation of a gearshift lever from the P position to another gear position.

### TECHNICAL FIELD

The present invention relates to a motor vehicle and a control method of the motor vehicle.

### BACKGROUND ART

One proposed motor vehicle is equipped with a mechanical parking lock unit that mechanically locks wheels in response to the driver's gearshift operation of a gearshift lever to a parking position and with a motor that is mechanically linked to the wheels (see, for example, Japanese Patent Laid-Open Gazette No. H9-286312). In this prior art motor vehicle, in response to a gearshift operation of the gearshift lever from the parking position to another gear position, the motor is controlled to output a torque in a direction of canceling a force acting in a longitudinal direction of the vehicle based on a road surface gradient. Such torque output causes the load applied to the mechanical parking lock unit to be substantially equal to zero and accordingly facilitates the gearshift operation of the gearshift lever from the parking position to another gear position (out-of-parting-position operation).

### DISCLOSURE OF THE INVENTION

In a motor vehicle that has a motor and another driving force source and runs with driving force from an engine and the driving force source, the out-of-parking-position operation may not be performed smoothly. This motor vehicle equipped with the motor and another driving force source runs with the driving force from both the motor and the driving force source. The motor mounted on this motor vehicle has a lower required power capacity, compared with the motor mounted on the prior art motor vehicle of the cited reference. On a relatively steep gradient of the road surface, the low-capacity motor can not output a sufficient driving force to cancel the force acting in the longitudinal direction of the vehicle. This leads to an unsmooth out-of-parking-position operation.

The motor vehicle and the control method of the motor vehicle of the invention thus aim to ensure a smooth gearshift operation of a gearshift lever from a parking position to another gear position.

In order to attain at least part of the above and the other related objects, the configurations and arrangements discussed below are applied to the motor vehicle and the control method of the motor vehicle of the invention.

The present invention is directed to a motor vehicle including: a first motor that outputs driving force to drive the motor vehicle; a driving force source that outputs driving force to drive the motor vehicle; a locking structure that locks an axle of the motor vehicle in a non-rotatable manner, in response to a driver's gearshift operation of a gearshift lever to a parking position; an out-of-parking-position operation prediction module that predicts a gear change operation from the parking position or an out-of-parking-position operation, for example, a gearshift operation of the gearshift lever from the parking position to another gear position; an auxiliary driving force setting module that sets an auxiliary driving force in a direction of canceling a vehicle weight force component or a force component of a vehicle weight in a longitudinal direction of the motor vehicle based on a road surface gradient; and a control module that, in response to prediction of the out-of-parking-position operation by the out-of-parking-position operation prediction module, controls the first motor to output the set auxiliary driving force when the auxiliary driving force is less than a preset driving force, while controlling the first motor and the driving force source to cooperatively output the set auxiliary driving force when the auxiliary driving force is not less than the preset driving force.

In the motor vehicle of the invention, in response to prediction of an out-of-parking-position operation, for example, a gearshift operation of the gearshift lever from the parking position to another gear position, the first motor is controlled to output the auxiliary driving force when the auxiliary driving force is less than the preset driving force. The auxiliary driving force is applied in the direction of canceling the vehicle weight force component or the force component of the vehicle weight acting in the longitudinal direction of the motor vehicle based on the road surface gradient. The first motor and the driving force source are controlled to cooperatively output the auxiliary driving force when the auxiliary driving force is not less than the preset driving force. Namely when the auxiliary driving force is less than the preset driving force, only the first motor is used to output the auxiliary driving force. When the auxiliary driving force is not less than the preset driving force, on the other hand, both the first motor and the driving force source are used to cooperatively output the auxiliary driving force. This arrangement effectively reduces the force in the longitudinal direction of the motor vehicle applied to the locking structure and thus ensures a smooth gearshift operation of the gearshift lever from the parking position to another gear position.

In one preferable embodiment of the motor vehicle of the invention, the out-of-parking-position operation is a combination of multiple operations, and the out-of-parking-position operation prediction module predicts the out-of-parking-position operation in response to execution of at least part of the multiple operations of the out-of-parking-position operation. For example, the out-of-parking-position operation may be a combination of the driver's depression of a brake pedal, an ON operation of a gearshift cancellation button to cancel prohibition of a gear change of the gearshift lever from the parking position to another gear position, and a gearshift operation of the gearshift lever from the parking position to another gear position. In this structure, the out-of-parking-position operation is predicted in response to the driver's depression of the brake pedal or in response to an ON operation of the gearshift cancellation button.

In the motor vehicle of the invention, the auxiliary driving force setting module may measure the road surface gradient and set the auxiliary driving force to increase with an increase in measured road surface gradient. The auxiliary driving force setting module may alternatively measure the vehicle weight force component and set the auxiliary driving force to increase with an increase in measured vehicle weight force component. These arrangements enable adequate setting of the auxiliary driving force and thus ensure a smooth gearshift operation of the gearshift lever from the parking position to another gear position.

In another preferable embodiment of the motor vehicle of the invention, the driving force source includes a second motor that outputs driving force to a different axle from the axle receiving the driving force output from the first motor, and the control module controls the first motor and the driving force source to ensure output of at least part of the auxiliary driving force from the second motor, when the auxiliary driving force is not less than the preset driving force. The driving force source may include an internal combustion engine that outputs driving force to drive the motor vehicle, and the control module may control the first motor and the driving force source to make the output driving force of the internal combustion engine supplement at least part of the auxiliary driving force, when the auxiliary driving force is not less than the preset driving force. In this structure, the driving force source may include: a three shaft-type power input output module that is linked to three shafts, that is, an output shaft of the internal combustion engine, a drive shaft linked to the axle, and a third shaft, and automatically determines power input from and output to a residual one shaft based on powers input from and output to any two shafts among the three shafts; and a generator that inputs and outputs power from and to the third shaft. The driving force source may alternatively include a pair-rotor motor that has a first rotor connected to an output shaft of the internal combustion engine and a second rotor connected to a drive shaft linked to the axle and is driven through relative rotation of the first rotor to the second rotor.

In the motor vehicle of the invention, the control module may control the locking structure to cancel locking of the axle, in response to the driver's out-of-parking-position operation. The locking structure may lock the axle in the non-rotatable state by gear engagement.

The present invention is directed to a control method of a motor vehicle having: a first motor that outputs driving force to drive the motor vehicle; a driving force source that outputs driving force to drive the motor vehicle; and a locking structure that locks an axle of the motor vehicle in a non-rotatable manner, in response to a driver's gearshift operation of a gearshift lever to a parking position, and the control method includes the steps of: a) predicting a gear change operation from the parking position or an out-of-parking-position operation, for example, a gearshift operation of the gearshift lever from the parking position to another gear position; b) setting an auxiliary driving force in a direction of canceling a vehicle weight force component or a force component of a vehicle weight in a longitudinal direction of the motor vehicle based on a road surface gradient; and c) in response to prediction of the out-of-parking-position operation by the step a), controlling the first motor to output the set auxiliary driving force when the auxiliary driving force is less than a preset driving force, while controlling the first motor and the driving force source to cooperatively output the set auxiliary driving force when the auxiliary driving force is not less than the preset driving force.

In the control method of the motor vehicle of the invention, in response to prediction of an out-of-parking-position operation, for example, a gearshift operation of the gearshift lever from the parking position to another gear position, the first motor is controlled to output the auxiliary driving force when the auxiliary driving force is less than the preset driving force. The auxiliary driving force is applied in the direction of canceling the vehicle weight force component or the force component of the vehicle weight acting in the longitudinal direction of the motor vehicle based on the road surface gradient. The first motor and the driving force source are controlled to cooperatively output the auxiliary driving force when the auxiliary driving force is not less than the preset driving force. Namely when the auxiliary driving force is less than the preset driving force, only the first motor is used to output the auxiliary driving force. When the auxiliary driving force is not less than the preset driving force, on the other hand, both the first motor and the driving force source are used to cooperatively output the auxiliary driving force. This arrangement effectively reduces the force in the longitudinal direction of the motor vehicle applied to the locking structure and thus ensures a smooth gearshift operation of the gearshift lever from the parking position to another gear position.

In one preferable embodiment of the control method of the motor vehicle of the invention, the out-of-parking-position operation is a combination of multiple operations, and the step a) predicts the out-of-parking-position operation in response to execution of at least part of the multiple operations of the out-of-parking-position operation. For example, the out-of-parking-position operation may be a combination of the driver's depression of a brake pedal, an ON operation of a gearshift cancellation button to cancel prohibition of a gear change of the gearshift lever from the parking position to another gear position, and a gearshift operation of the gearshift lever from the parking position to another gear position. In this structure, the out-of-parking-position operation is predicted in response to the driver's depression of the brake pedal or in response to an ON operation of the gearshift cancellation button.

In the control method of the motor vehicle of the invention, the step b) may measure the road surface gradient and set the auxiliary driving force to increase with an increase in measured road surface gradient. The step b) may alternatively measure the vehicle weight force component and set the auxiliary driving force to increase with an increase in measured vehicle weight force component. These arrangements enable adequate setting of the auxiliary driving force and thus ensure a smooth gearshift operation of the gearshift lever from the parking position to another gear position.

In another preferable embodiment of the control method of a motor vehicle of the invention, the driving force source include a second motor that outputs driving force to a different axle from the axle receiving the driving force output from the first motor, and the step c) controls the first motor and the driving force source to ensure output of at least part of the auxiliary driving force from the second motor, when the auxiliary driving force is not less than the preset driving force. The driving force source may include an internal combustion engine that outputs driving force to drive the motor vehicle, and the step c) may control the first motor and the driving force source to make the output driving force of the internal combustion engine supplement at least part of the auxiliary driving force, when the auxiliary driving force is not less than the preset driving force. The step c) may control the locking structure to cancel locking of the axle, in response to the driver's out-of-parking-position operation.

### BRIEF DESCRIPTION OF THE DRAWINGS

FIG. 1 schematically illustrates the configuration of a hybrid vehicle in one embodiment of the invention;

FIG. 2 is a flowchart showing a control routine at gear change from a parking position (P position) executed by a hybrid electronic control unit mounted on the hybrid vehicle of the embodiment;

FIG. 3 shows a coefficient setting map;

FIG. 4 shows a relation between a vehicle weight force component FM and an auxiliary driving force F* at a road surface gradient θ;

FIG. 5 is a flowchart showing a modified control routine at gear change from the P position; and

FIG. 6 schematically illustrates the configuration of another hybrid vehicle in one modified example.

### BEST MODES OF CARRYING OUT THE INVENTION

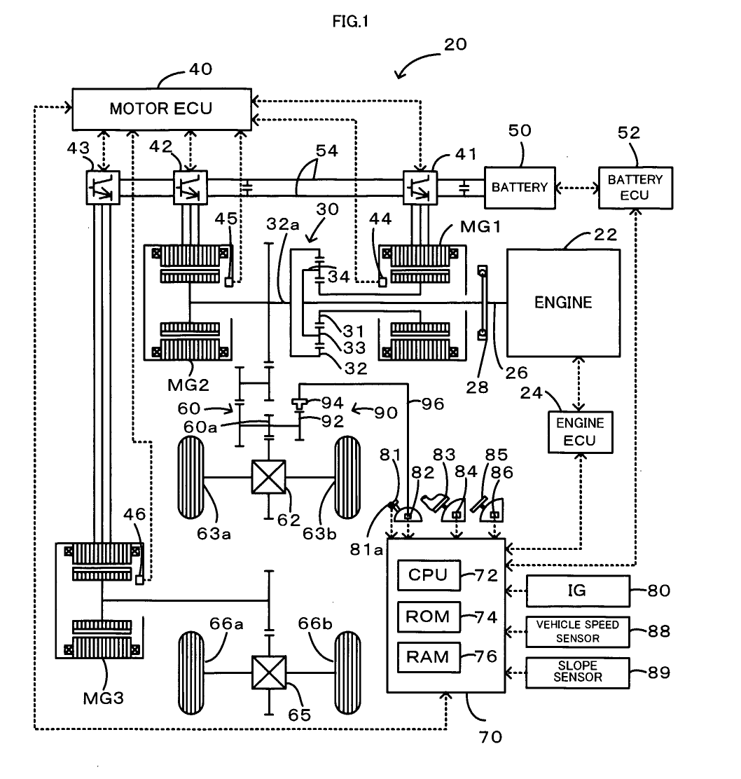

One mode of carrying out the invention is described below as a preferred embodiment. FIG. 1 schematically illustrates the configuration of a hybrid vehicle 20 in one embodiment of the invention. As shown in FIG. 1, the hybrid vehicle 20 of the embodiment includes an engine 22, a three shaft-type power distribution integration mechanism 30 that is connected to a crankshaft 26 or an output shaft of the engine 22 via a damper 28, a motor MG1 that is connected to the power distribution integration mechanism 30 and is capable of generating electric power, a motor MG2 that is connected to the power distribution integration mechanism 30 and to a ring gear shaft 32a linked to front wheels 63a and 63b via a differential gear 62, a motor MG3 that is linked to rear wheels 66a and 66b via a differential gear 65, and a hybrid electronic control unit 70 that controls the operations of the whole hybrid vehicle 20.

The engine 22 is an internal combustion engine that uses a hydrocarbon fuel, such as gasoline or light oil, to output power. An engine electronic control unit (hereafter referred to as engine ECU) 24 receives signals from diverse sensors that detect operating conditions of the engine 22, and takes charge of operation control of the engine 22, for example, fuel injection control, ignition control, and intake air flow regulation. The engine ECU 24 communicates with the hybrid electronic control unit 70 to control operations of the engine 22 in response to control signals transmitted from the hybrid electronic control unit 70 while outputting data relating to the operating conditions of the engine 22 to the hybrid electronic control unit 70 according to the requirements.

The power distribution and integration mechanism 30 has a sun gear 31 that is an external gear, a ring gear 32 that is an internal gear and is arranged concentrically with the sun gear 31, multiple pinion gears 33 that engage with the sun gear 31 and with the ring gear 32, and a carrier 34 that holds the multiple pinion gears 33 in such a manner as to allow free revolution thereof and free rotation thereof on the respective axes. Namely the power distribution and integration mechanism 30 is constructed as a planetary gear mechanism that allows for differential motions of the sun gear 31, the ring gear 32, and the carrier 34 as rotational elements. The carrier 34, the sun gear 31, and the ring gear 32 in the power distribution and integration mechanism 30 are respectively coupled with the crankshaft 26 of the engine 22, the motor MG1, and the reduction gear 35 via ring gear shaft 32a. While the motor MG1 functions as a generator, the power output from the engine 22 and input through the carrier 34 is distributed into the sun gear 31 and the ring gear 32 according to the gear ratio. While the motor MG1 functions as a motor, on the other hand, the power output from the engine 22 and input through the carrier 34 is combined with the power output from the motor MG1 and input through the sun gear 31 and the composite power is output to the ring gear 32. The power output to the ring gear 32 is thus finally transmitted to the driving wheels 63a and 63b via the gear mechanism 60, and the differential gear 62 from ring gear shaft 32a.

The gear mechanism 60 is joined with a parking lock mechanism 90, which includes a parking gear 92 that is attached to a final gear 60a, and a parking lock pole 94 that engages with the parking gear 92 to lock the parking gear 92 in a non-rotatable state. The parking lock pole 94 is activated by transmission of a gearshift operation of a gearshift lever 81 from another gear position to a parking position (P position) or a gearshift operation from the P position to another gear position via a shift cable 96. The parking lock pole 94 engages with and disengages from the parking gear 92 to activate and release the parking lock. The final gear 60a is mechanically linked to the front wheels 63a and 63b. The parking lock mechanism 90 thus indirectly locks the front wheels 63a and 63b.

The motors MG1, MG2, and MG3 are all constructed as known synchronous motor generators that may be actuated both as a generator and as a motor. The motors MG1, MG2, and MG3 transmit electric powers to and from a battery 50 via inverters 41, 42, and 43. Power lines 54 connecting the battery 50 with the inverters 41, 42, and 43 are structured as common positive bus and negative bus shared by the inverters 41, 42, and 43. Such connection enables electric power generated by any one of the motors MG1, MG2, and MG3 to be consumed by another motor. The battery 50 may thus be charged with surplus electric power generated by any one of the motors MG1, MG2, and MG3, while being discharged to supplement insufficient electric power. The battery 50 is neither charged nor discharged, while the input and output of electric powers are balanced among the motors MG1, MG2, and MG3. All the motors MG1, MG2, and MG3 are driven and controlled by a motor electronic control unit (hereafter referred to as motor ECU) 40. The motor ECU 40 inputs signals required for driving and controlling the motors MG1, MG2, and MG3, for example, signals representing rotational positions of rotors in the motors MG1, MG2, and MG3 from rotational position detection sensors 44, 45, and 46 and signals representing phase currents to be applied to the motors MG1, MG2, and MG3 from current sensors (not shown). The motor ECU 40 outputs switching control signals to the inverters 41, 42, and 43. The motor ECU 40 executes a rotation speed computation routine (not shown) to calculate rotation speeds Nm1, Nm2, and Nm3 of the rotors of the motors MG1, MG2, and MG3 and a rotation speed Nr of the ring gear shaft 32a from the input signals from the rotational position detection sensors 44, 45, and 46. The motor ECU 40 establishes communication with the hybrid electronic control unit 70 to drive and control the motors MG1, MG2, and MG3 in response to control signals received from the hybrid electronic control unit 70, while outputting data regarding the driving conditions of the motors MG1, MG2, and MG3 to the hybrid electronic control unit 70 according to the requirements.

The battery 50 is under control of a battery electronic control unit (hereafter referred to as battery ECU) 52. The batter ECU 52 inputs signals required for management of the battery 50, for example, an inter-terminal voltage Vb from a voltage sensor (not shown) located between terminals of the battery 50, a charge-discharge current Ib from a current sensor (not shown) located in the power line 54 connecting with an output terminal of the battery 50, and a battery temperature Tb from a temperature sensor (not shown) attached to the battery 50. The battery ECU 52 outputs data regarding the conditions of the battery 50 to the hybrid electronic control unit 70 by communication according to the requirements. For management of the battery 50, the battery ECU 52 computes a remaining charge level or current state of charge (SOC) of the battery 50 from an integration of the charge-discharge current measured by the current sensor (not shown).

The hybrid electronic control unit 70 is constructed as a microprocessor including a CPU 72, a ROM 74 that stores processing programs, a RAM 76 that temporarily stores data, input and output ports (not shown), and a communication port (not shown). The hybrid electronic control unit 70 receives, via its input port, an ignition signal from an ignition switch 80, a gearshift position SP currently set by the gearshift lever 81 from a gearshift position sensor 82, a cancellation signal from a gearshift cancellation button 81a to cancel prohibition of a gearshift operation of the gearshift lever 81 from the parking position (P position) to another gear position, an accelerator opening Acc or the driver's depression amount of an accelerator pedal 83 from an accelerator pedal position sensor 84, a brake pedal position BP or the driver's depression amount of a brake pedal 85 from a brake pedal position sensor 86, a vehicle speed V of the hybrid vehicle 20 from a vehicle speed sensor 88, and a road surface gradient θ in the longitudinal direction of the hybrid vehicle 20 from a slope sensor 89. The hybrid electronic control unit 70 establishes communication with the engine ECU 24, the motor ECU 40, and the battery ECU 52 via its communication port to receive and send the diversity of control signals and data from and to the engine ECU 24, the motor ECU 40, and the battery ECU 52, as mentioned above.

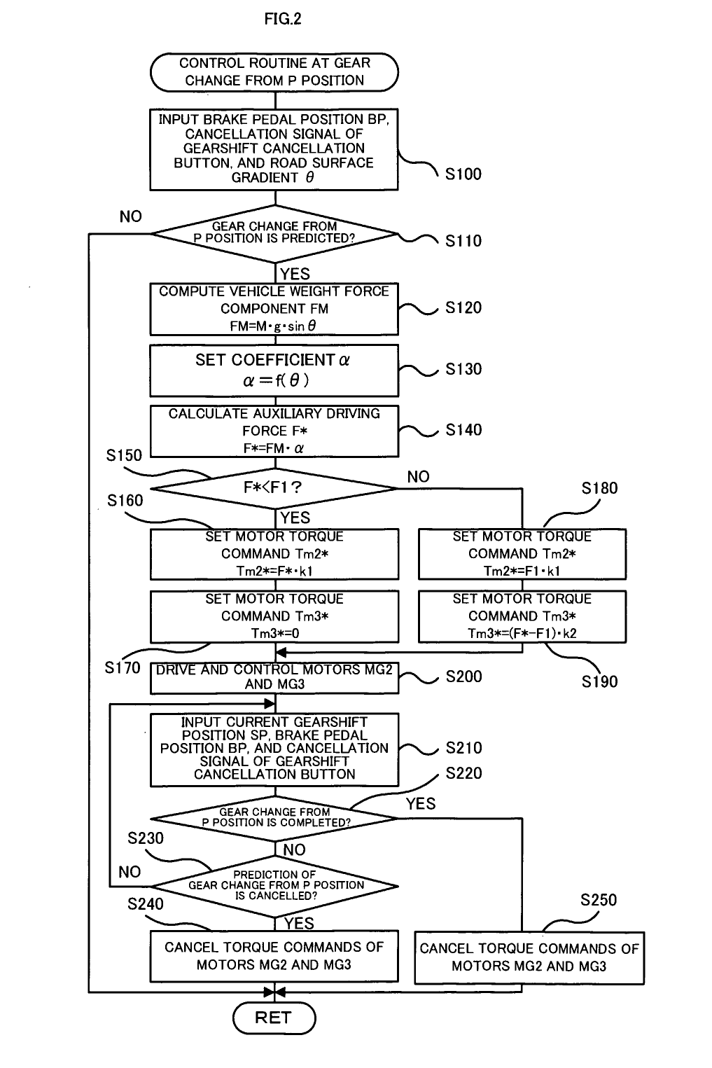

The following description regards the operations of the hybrid vehicle 20 of the embodiment configured as discussed above, especially a series of control in response to a gearshift operation of the gearshift lever from the P position to another gear position. FIG. 2 is a flowchart showing a control routine at gear change from the P position. This routine is repeatedly executed when the gearshift position SP is at the P position.

In the control routine at gear change from the P position, the CPU 72 of the hybrid electronic control unit 70 first inputs the brake pedal position BP from the brake pedal position sensor 86, the cancellation signal from the gearshift cancellation button 81a to cancel prohibition of the gearshift operation of the gearshift lever 81 from the P position to another gear position, and the road surface gradient θ in the longitudinal direction of the hybrid vehicle 20 from the slope sensor 89 (step S100). The CPU 72 then determines whether a gear change from the P position is predicted, based on the input brake pedal position BP and the input cancellation signal (step S110). The gear change from the P position represents a gearshift operation of the gearshift lever 81 from the P position to another gear position in the ON state of the gearshift cancellation button 81a during the driver's depression of the brake pedal 85. The gear change from the P position is predicted in response to an ON operation of the gearshift cancellation button 81a concurrently with the driver's depression of the brake pedal 85. This control routine is immediately terminated in the case of no prediction of the gear change from the P position.

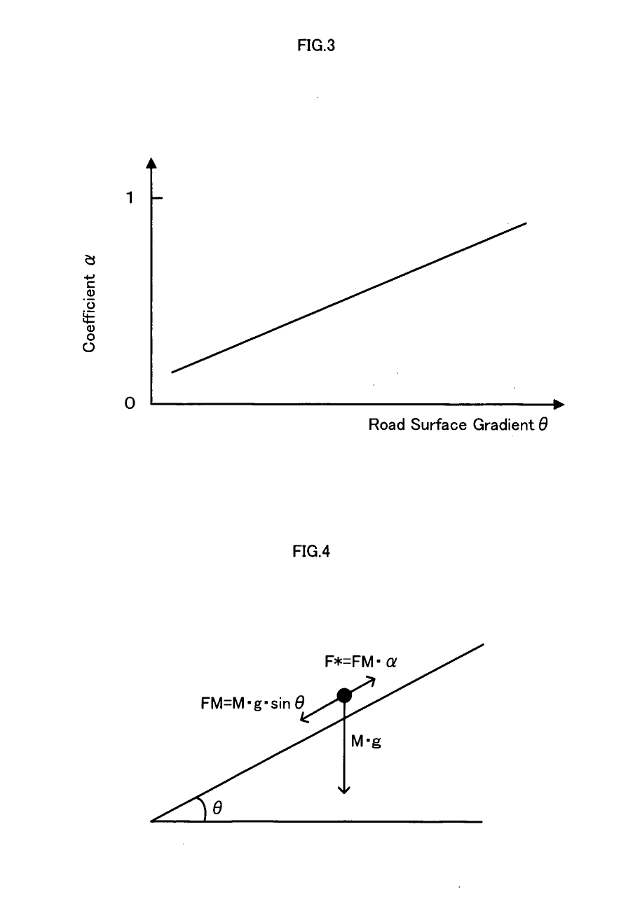

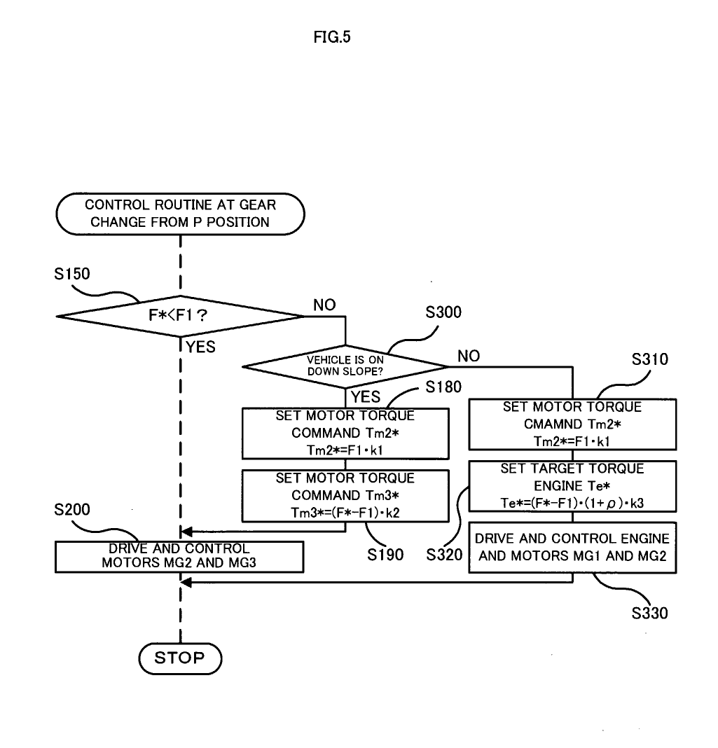

In the case of prediction of the gear change from the P position, on the other hand, the CPU 72 computes a vehicle weight force component FM (=M·g·sin θ), which is a force component of a vehicle weight M in the longitudinal direction of the hybrid vehicle 20, from the input road surface gradient θ and the gravity acceleration g (step S120). The CPU 72 set a coefficient α based on the road surface gradient θ (step S130) and multiples the vehicle weight force component FM by the coefficient α to calculate an auxiliary driving force F* to be output to the hybrid vehicle 20 (step S140). In this embodiment, the vehicle weight M represents the total weight of the hybrid vehicle 20 with a driver. The coefficient α is used to determine the reduction degree of the force applied to the parking lock mechanism 90 corresponding to the vehicle weight force component FM. The procedure of this embodiment stores in advance a variation in coefficient a against the road surface gradient θ as a coefficient setting map in the ROM 74 and reads the coefficient α corresponding to the given road surface gradient θ from the coefficient setting map. FIG. 3 shows one example of the coefficient setting map. The coefficient α is set to increase in a range of 0 to 1 with an increase in road surface gradient θ. Such setting interferes with an increase in force in the longitudinal direction of the vehicle applied to the parking lock mechanism 80 according to the vehicle weight force component FM and the auxiliary driving force F* with an increase in road surface gradient θ. FIG. 4 shows the relation between the vehicle weight force component FM and the auxiliary driving force F* at the road surface gradient θ.

The auxiliary driving force F* is compared with a preset driving force F1 (step S150). The driving force F1 is used as a criterion for determining whether the auxiliary driving force F* is to be output from only the motor MG2 or to be output from both the motors MG2 and MG3, and is set to be smaller than a maximum rated torque of the motor MG2. When the auxiliary driving force F* is less than the preset driving force F1, the CPU 72 multiplies the auxiliary driving force F* by a conversion factor k1 to set a torque command Tm2* of the motor MG2 and sets a torque command Tm3* of the motor MG3 to 0 (steps S160 and S170). When the auxiliary driving force F* is not less than the preset driving force F1, on the other hand, the CPU 72 multiplies the preset driving force F1 by the conversion factor k1 to set the torque command Tm2* of the motor MG2 and multiplies the difference between the auxiliary driving force F* and the preset driving force F1 by a conversion coefficient k2 to set the torque command Tm3* of the motor MG3 (steps S180 and S190). The motors MG2 and MG3 are driven and controlled with the settings of the torque commands Tm2* and Tm3* (step S200). The conversion factors k1 and k2 are used to convert the driving force into torques of the motors MG2 and MG3. The concrete procedure of the drive control of the motors MG2 and MG3 sends the settings of the torque commands Tm2* and Tm3* to the motor ECU 40. The motor ECU 40 then executes switching control of switching elements in the inverters 42 and 43 to drive the motors MG2 and MG3 with the received settings of the torque commands Tm2* and Tm3*. The gear change from the P position is predicted in response to an ON operation of the gearshift cancellation button 81a concurrently with the driver's depression of the brake pedal 85. In this case, when the auxiliary driving force F* is less than the preset driving force F1, the motor MG2 is controlled to output a torque corresponding to the auxiliary driving force F*. When the auxiliary driving force F* is not less than the preset driving force F1, on the other hand, the motors MG2 and MG3 are controlled to cooperatively output a torque corresponding to the auxiliary driving force F*. This arrangement thus effectively reduces the force in the longitudinal direction of the hybrid vehicle 20 acting between the parking gear 92 and the parking lock pole 94 in the parking lock mechanism 90 that indirectly locks the front wheels 63a and 63b. The reduced force enables the driver to smoothly change the position of the gearshift lever 81 from the P position to another gear position.

The CPU 72 subsequently inputs the current gearshift position SP from the gearshift position sensor 82, the brake pedal position BP from the brake pedal position sensor 86, and the cancellation signal from the gearshift cancellation button 81a (step S210) and determines whether the input current gearshift position SP is at the gear position other than the P position, in order to detect completion of the gear change from the P position (step S220). In the case of no completion of the gear change from the P position, the CPU 72 detects a release of the brake pedal 85 or an OFF operation of the gearshift cancellation button 81a to determine whether prediction of the gear change from the P position is cancelled (step S230). In the case of no cancellation of prediction of the gear change from the P position prior to completion of the gear change from the P position, the control routine returns to step S210. The processing of steps S210 to S230 is repeated to wait for completion of the gear change from the P position. The CPU 72 then cancels the torque commands Tm2* and Tm3* of the motors MG2 and MG3 (step S250) and exits from this control routine. After completion of the gear change from the P position, this control routine is not executed subsequently. In the case of cancellation of prediction of the gear change from the P position by release of the brake pedal 85 or the OFF operation of the gearshift cancellation button 81a, prior to completion of the gear change from the P position, the CPU 72 cancels the torque commands Tm2* and Tm3* of the motors MG2 and MG3 (step S240) and exits from this control routine.

In the hybrid vehicle 20 of the embodiment described above, in the case of prediction of a gear change from the P position, when the auxiliary driving force F* applied in the direction of canceling the vehicle weight force component FM based on the road surface gradient θ is less than a preset driving force F1, the motor MG2 is controlled to output the torque corresponding to the auxiliary driving force F*. When the auxiliary driving force F* is not less than the preset driving force F1, on the other hand, the motors MG2 and MG3 are controlled to cooperatively output the torque corresponding to the auxiliary driving force F*. This arrangement effectively reduces the force in the longitudinal direction of the hybrid vehicle 20 applied to the parking lock mechanism 90. The reduced force enables the driver to smoothly change the position of the gearshift lever 81 from the P position to another gear position.

In the hybrid vehicle 20 of the embodiment, the gear change from the P position is predicted in response to an ON operation of the gearshift cancellation button 81a concurrently with the driver's depression of the brake pedal 85. The gear change from the P position may otherwise be predicted in response to either of the driver's depression of the brake pedal 85 or an ON operation of the gearshift cancellation button 81a.

The hybrid vehicle 20 of the embodiment computes the vehicle weight force component FM from the road surface gradient θ detected by the slope sensor 89. The hybrid vehicle 20 may be provided with a G sensor for detecting the acceleration in the longitudinal direction of the vehicle, in place of or in addition to the slope sensor 89, and may compute the vehicle weight force component FM from the measured value of the G sensor.

The hybrid vehicle 20 of the embodiment sets the torque commands Tm2* and Tm3* of the motor MG2 and MG3, based on the vehicle weight force component FM computed from the road surface gradient θ. One modified procedure may not compute the vehicle weight force component FM, but may compute the force in the longitudinal direction of the vehicle applied to the parking lock mechanism 90, from the road surface gradient θ. The torque commands Tm2* and Tm3* of the motors MG3 and MG3 are set based on this computed force.

In the hybrid vehicle 20 of the embodiment, the coefficient α is set to increase with an increase in road surface gradient θ as shown in the coefficient setting map of FIG. 3. The coefficient α may be fixed to a preset value in the range of 0 to 1.

In the hybrid vehicle 20 of the embodiment, the auxiliary driving force F* is calculated by multiplying the vehicle weight force component FM by the coefficient α. One modified procedure may subtract a preset value from the vehicle weight force component FM to set the auxiliary driving force F*. The auxiliary driving force F* may otherwise be set to make the difference between the auxiliary driving force F* and the vehicle weight force component FM equal to a preset value.

In the hybrid vehicle 20 of the embodiment, the identical driving force F1 is used to be compared with the auxiliary driving force F* at step S150 and to set the torque command Tm2* of the motor MG2 at step S180. Different driving forces may be used for the comparison and for the setting of the torque command Tm2*. For example, when the auxiliary driving force F* is not less than the preset driving force F1 (step S150), the modified procedure sets the torque command Tm2* (=F2·k1) of the motor MG2 corresponding to a driving force F2 that is smaller than the preset driving force F1 (S180), and sets the torque command Tm3* (=(F*−F2)·k2) of the motor MG3 (step S190).

In the hybrid vehicle 20 of the embodiment, when the auxiliary driving force F* is not less than the preset driving force F1, the control routine sets the torque command Tm2* of the motor MG2 based on the preset driving force F1 (step S180) and sets the torque command Tm3* of the motor MG3 based on the residual driving force (F*−F1) (step S190). Another method may be adopted to set the torque commands Tm2* and Tm3* of the motors MG2 and MG3, in order to cooperatively output the torque corresponding to the auxiliary driving force F*. One modified procedure multiplies the auxiliary driving force F* by a preset ratio x (0<x<1) to set the torque command Tm2* (=F*·x) of the motor MG2, while setting the torque command Tm3* of the motor MG3 based on the residual driving force (F*·(1−x).

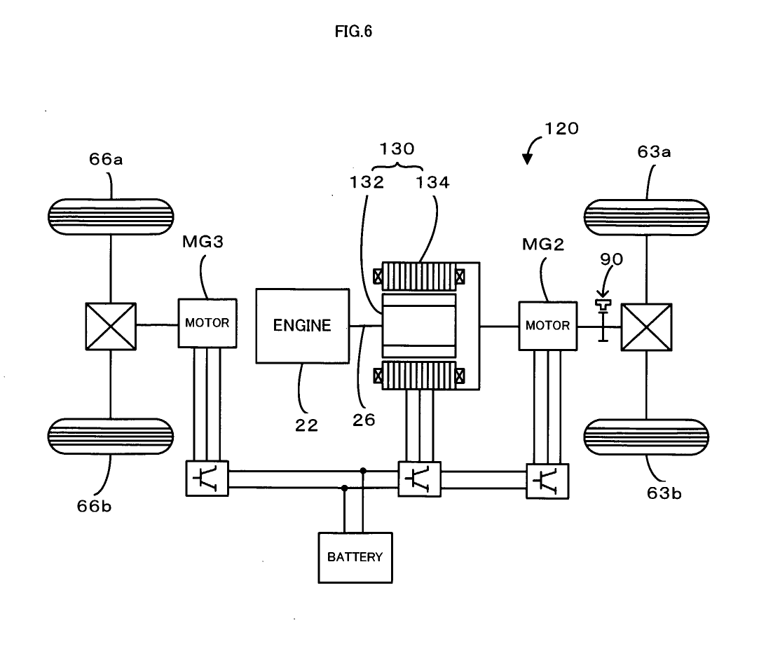

The hybrid vehicle 20 of the embodiment controls the motors MG2 and MG3 to cooperatively output the torque corresponding to the auxiliary driving force F*, when the auxiliary driving force F* is not less than the preset driving force F1. One modified procedure may control the engine 22 and the motors MG1 and MG2 to cooperatively output the auxiliary driving force F* upon satisfaction of a preset condition. A control routine at gear change from the P position according to this modified procedure is partly shown in the flowchart of FIG. 5. In this modified control routine at gear change from the P position, when it is determined at step S150 that the auxiliary driving force F* is not less than the preset driving force F1, the modified control routine determines whether the current position of the vehicle is on a down slope according to the input road surface gradient θ (step S300). When the vehicle is on the down slope, the modified control routine sets the torque commands Tm2* and Tm3* of the motors MG2 and MG3 (steps S180 and S190) and drives and controls the motors MG2 and MG3 with the settings of the torque commands Tm2* and Tm3* (step S200) as described above. The modified control routine then executes the processing of and after step S210. When the vehicle is not on the down slope, on the other hand, the modified control routine sets the torque command Tm2* of the motor MG2 (step S310) in the same manner as step S180. The modified control routine then sets a target torque Te* of the engine 22 based on the difference (F*−F1) between the auxiliary driving force F* and the preset driving force F1 and a gear ratio ρ of the power distribution integration mechanism 30 according to Equation (1) given below (step S320):

Te*=(F*−F1)·(1+ρ)·k3 (1)

The modified control routine controls the engine 22 to be driven an efficient drive point with the target torque Te*, controls the motor MG1 to output a reactive force to the output of the engine 22, and controls the motor MG2 to be driven with the torque command Tm2* (step S330). The modified control routine subsequently executes the processing of and after step S210. In equation (1) given above, ‘k3’ represents a conversion factor for converting the driving force into a torque of the engine 22. When the auxiliary driving force F* is not less than the preset driving force F1 and the vehicle is not on the down slope, the engine 22 and the motors MG1 and MG2 are controlled to cooperatively output the torque corresponding to the auxiliary driving force F*. This control effectively reduces the force in the longitudinal direction of the vehicle applied to the parking lock mechanism 90.

In the hybrid vehicle 20 of the embodiment, the output power of the engine 22 is transmitted to the front wheels 63a and 63b via the power distribution integration mechanism 30. The technique of the invention is applicable to a hybrid vehicle 220 of a modified structure shown in FIG. 6. The hybrid vehicle 220 is equipped with a pair rotor motor 130, which includes an inner rotor 132 connected to the crankshaft 26 of the engine 22 and an outer rotor 134 mechanically linked to the front wheels 63a and 63b. The pair rotor motor 130 transmits part of the output power of the engine 22 to the front wheels 63 and 63b, while converting the residual engine power into electric power.

In the hybrid vehicle 20 of the embodiment, at least part of the driving force output from the engine 22 is transmitted to the front wheels 63a and 63b via the power distribution integration mechanism 30. The driving force output from the engine 22 may be transmitted directly or through speed change to the front wheels 63a and 63b or to the rear wheels 66a and 66b. In this modified structure, the motor MG3 may be omitted from the hybrid vehicle 20 of the embodiment.

The embodiment regards the hybrid vehicle where the driving force of the internal combustion engine and the driving force of the first motor are output to the first axle, while the driving force of the second motor is output to the second axle. The technique of the invention is not restricted to the hybrid vehicles but is also applicable to electric vehicles without an internal combustion engine. In the electric vehicle, the driving force of the first motor is output to the first axle, while the driving force of the second motor is output to the second axle.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

### INDUSTRIAL APPLICABILITY

The present invention is preferably applicable to automobile manufacturing industries.

1. A motor vehicle, comprising:
a first motor that outputs driving force to drive said motor vehicle;
a driving force source that outputs driving force to drive said motor vehicle;
a locking structure that locks an axle of said motor vehicle in a non-rotatable manner, in response to a driver's gearshift operation of a gearshift lever to a parking position;
an out-of-parking-position operation prediction module that predicts a gear change operation from the parking position or an out-of-parking-position operation, for example, a gearshift operation of the gearshift lever from the parking position to another gear position;
an auxiliary driving force setting module that sets an auxiliary driving force in a direction of canceling a vehicle weight force component or a force component of a vehicle weight in a longitudinal direction of said motor vehicle based on a road surface gradient; and
a control module that, in response to prediction of the out-of-parking-position operation by said out-of-parking-position operation prediction module, controls the first motor to output the set auxiliary driving force when the auxiliary driving force is less than a preset driving force, while controlling the first motor and the driving force source to cooperatively output the set auxiliary driving force when the auxiliary driving force is not less than the preset driving force.

2. A motor vehicle in accordance with claim 1, wherein the out-of-parking-position operation is a combination of multiple operations, and
said out-of-parking-position operation prediction module predicts the out-of-parking-position operation in response to execution of at least part of the multiple operations of the out-of-parking-position operation.

3. A motor vehicle in accordance with claim 1, wherein said auxiliary driving force setting module measures the road surface gradient and sets the auxiliary driving force to increase with an increase in measured road surface gradient.

4. A motor vehicle in accordance with claim 1, wherein said auxiliary driving force setting module measures the vehicle weight force component and sets the auxiliary driving force to increase with an increase in measured vehicle weight force component.

5. A motor vehicle in accordance with claim 1, wherein the driving force source comprises a second motor that outputs driving force to a different axle from the axle receiving the driving force output from the first motor, and
said control module controls the first motor and the driving force source to ensure output of at least part of the auxiliary driving force from the second motor, when the auxiliary driving force is not less than the preset driving force.

6. A motor vehicle in accordance with claim 1, wherein the driving force source comprises an internal combustion engine that outputs driving force to drive said motor vehicle, and
said control module controls the first motor and the driving force source to make the output driving force of the internal combustion engine supplement at least part of the auxiliary driving force, when the auxiliary driving force is not less than the preset driving force.

7. A motor vehicle in accordance with claim 6, wherein the driving force source comprises:
a three shaft-type power input output module that is linked to three shafts, that is, an output shaft of the internal combustion engine, a drive shaft linked to the axle, and a third shaft, and automatically determines power input from and output to a residual one shaft based on powers input from and output to any two shafts among the three shafts; and
a generator that inputs and outputs power from and to the third shaft.

8. A motor vehicle in accordance with claim 6, wherein the driving force source comprises a pair-rotor motor that has a first rotor connected to an output shaft of the internal combustion engine and a second rotor connected to a drive shaft linked to the axle and is driven through relative rotation of the first rotor to the second rotor.

9. A motor vehicle in accordance with claim 1, wherein said control module controls the locking structure to cancel locking of the axle, in response to the driver's out-of-parking-position operation.

10. A motor vehicle in accordance with claim 1, wherein the locking structure locks the axle in the non-rotatable state by gear engagement.

11. A control method of a motor vehicle including: a first motor that outputs driving force to drive said motor vehicle; a driving force source that outputs driving force to drive said motor vehicle; and a locking structure that locks an axle of said motor vehicle in a non-rotatable manner, in response to a driver's gearshift operation of a gearshift lever to a parking position, said control method comprising the steps of:
a) predicting a gear change operation from the parking position or an out-of-parking-position operation, for example, a gearshift operation of the gearshift lever from the parking position to another gear position;
b) setting an auxiliary driving force in a direction of canceling a vehicle weight force component or a force component of a vehicle weight in a longitudinal direction of said motor vehicle based on a road surface gradient; and
c) in response to prediction of the out-of-parking-position operation by said step a), controlling the first motor to output the set auxiliary driving force when the auxiliary driving force is less than a preset driving force, while controlling the first motor and the driving force source to cooperatively output the set auxiliary driving force when the auxiliary driving force is not less than the preset driving force.

12. A control method of a motor vehicle in accordance with claim 11, wherein the out-of-parking-position operation is a combination of multiple operations, and
said step a) predicts the out-of-parking-position operation in response to execution of at least part of the multiple operations of the out-of-parking-position operation.

13. A control method of a motor vehicle in accordance with claim 11, wherein said step b) measures the road surface gradient and sets the auxiliary driving force to increase with an increase in measured road surface gradient.

14. A control method of a motor vehicle in accordance with claim 11, wherein said step b) measures the vehicle weight force component and sets the auxiliary driving force to increase with an increase in measured vehicle weight force component.

15. A control method of a motor vehicle in accordance with claim 11, wherein the driving force source comprises a second motor that outputs driving force to a different axle from the axle receiving the driving force output from the first motor, and
said step c) controls the first motor and the driving force source to ensure output of at least part of the auxiliary driving force from the second motor, when the auxiliary driving force is not less than the preset driving force.

16. A control method of a motor vehicle in accordance with claim 11, wherein the driving force source comprises an internal combustion engine that outputs driving force to drive said motor vehicle, and
said step c) controls the first motor and the driving force source to make the output driving force of the internal combustion engine supplement at least part of the auxiliary driving force, when the auxiliary driving force is not less than the preset driving force.

17. A control method of a motor vehicle in accordance with claim 11, wherein said step c) controls the locking structure to cancel locking of the axle, in response to the driver's out-of-parking-position operation.
